(19) United States
(12) Patent Application Publication
(10) Pub. No.: US 2008/0267296 A1
(43) Pub. Date: Oct. 30, 2008

(54) METHOD AND APPARATUS FOR CONCEALING AN ERROR OF AN IMAGE USING RESIDUAL DATA

(75) Inventors: Seung-Woo Shin, Yongin-si (KR); So-an Kwon, seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/923,002

(22) Filed: Oct. 24, 2007

(30) Foreign Application Priority Data
Apr. 24, 2007 (KR) 2007-40057

(51) Int. Cl. H04N 7/68; H04N 7/26

(52) U.S. Cl. 375/240.24; 375/240.16; 375/240.27; 382/254; 375/E07.281; 375/E07.125

(57) ABSTRACT

A method and apparatus for concealing an error of an image, the method including: detecting a block in which the error occurs from a current picture; searching a reference picture decoded before the current picture using residual data of the detected block; and concealing an error of the detected block based on the searching of the reference picture and information about a location of the detected block in the current picture. Accordingly, the block in which the error occurs can be effectively restored without a receiver receiving image data or performing complex operations.

### CROSS-REFERENCE TO RELATED APPLICATION

This application claims the benefit of Korean Application No-2007-40057, filed on Apr. 24, 2007 in the Korean Intellectual Property Office, the disclosure of which is incorporated herein by reference.

### BACKGROUND OF THE INVENTION

1. Field of the Invention

Aspects of the present invention relate to a method and apparatus for concealing an error of an image, and more particularly, to a method and apparatus for efficiently restoring a block in which an error occurred without complex operations.

2. Description of the Related Art

According to a general image compression method (such as MPEG-1, MPEG-2, or MPEG-4 H.264/MPEG 4 AVC (Advanced Video Coding), an image is encoded using an intra picture (hereinafter, referred to as an I picture) and a predictive picture (hereinafter, referred to as a P picture).

FIG. 1 illustrates a conventional image sequence. Referring to FIG. 1, an I picture is periodically generated in a uniform time interval by encoding a picture independently of pictures sequentially preceding or proceeding the picture by using spatial redundancy in the picture. A motion prediction for removing temporal redundancy is not used, and the encoding is performed using only information included in the picture.

A P picture is a picture obtained by performing inter prediction between pictures. In other words, the P picture is obtained by removing temporal redundancy by performing inter prediction between pictures using an I picture or another P picture as a reference picture.

In MPEG-4 H.264/MPEG 4 AVC, when a block in which an error occurs (i.e., when a missing block is detected while restoring a P picture by decoding the encoded P picture), the missing block is restored by performing a temporal error concealment. This will now be described in detail with reference to FIG. 2.

FIG. 2 illustrates a conventional method of concealing a temporal error. In FIG. 2, a current block 210 is lost while transmitting image data, and thus needs to be restored.

According to the conventional method of concealing a temporal error, a receiver that receives the image data uses blocks 220 through 250 adjacent to the current block 210 in order to restore the current block 210.

A motion vector of the current block 210 is predicted based on a top block 220 of the current block 210, a left block 230 of the current block 210, a bottom block 240 of the current block 210, and a right block 250 of the current block 210. First, candidates for the motion vector of the current block 210 are selected by referring to motion vectors of the blocks 220 through 250 adjacent to the current block 210.

When all of the candidates are selected, reference blocks are selected by searching a reference picture according to each candidate. In MPEG-4 H.264/MPEG 4 AVC, a total of 8 candidates are selected by selecting two candidates from each of the blocks 220 through 250. The reference picture is searched accordingly in order to select a total of 8 reference blocks.

When the reference blocks are selected, the current block 210 is restored by performing a boundary matching algorithm (BMA) on the selected reference blocks. The selected reference blocks are located on the current block 210, sum of absolute differences (SAD) values between pixels located on the external boundaries of the reference blocks are calculated, and pixels located on the boundaries of the blocks 220 through 250 are calculated. A reference block having the least SAD value is selected as a restoration block of the current block 210.

However, using the method illustrated in FIG. 2, numerous operations must be performed while calculating SAD values of the 8 reference blocks selected from the candidates. Also, when the candidates selected from the blocks 220 through 250 are different from the motion vector of the current block 210, the current block 210 cannot be suitably restored using the BMA.

Accordingly, a method and apparatus for accurately concealing an error in a portable terminal, such as a mobile terminal that is short of hardware resources, are required.

### SUMMARY OF THE INVENTION

Aspects of the present invention provide a method and apparatus for concealing an error of an image, the method and apparatus minimizing a number of operations required in concealing the error.

Aspects of the present invention also provide a computer-readable recording medium having recorded thereon a program to execute the above method.

According to an aspect of the present invention, there is provided a method of concealing an error of an image, the method including: detecting a block in which the error occurs from a current picture; searching a reference picture decoded before the current picture using residual data of the detected block; and concealing the error of the detected block based on the searching of the reference picture and information about a location of the detected block in the current picture.

The searching of the reference picture may include: generating feature points of the reference picture; and restoring a motion vector of the detected block by comparing the generated feature points of the reference picture and the residual data of the detected block.

According to another aspect of the present invention, there is provided an apparatus for concealing an error of an image, the apparatus including: an error detector to detect a block in which the error occurs from a current picture; a searcher to search a reference picture decoded before the current picture using residual data of the detected block; and an error concealer to conceal an error of the detected block based on a searching result of the searcher and information about a location of the detected block in the current picture.

The searcher may include: a feature point generator to generate feature points of the reference picture; and a motion vector restorer to restore a motion vector of the detected block by comparing the generated feature points of the reference picture and the residual data of the detected block.

According to another aspect of the present invention, there is provided a method of transmitting image data, the method including: classifying information about a location of a current block in a current picture into a first image data transmission unit, a motion vector of the current block into a second image data transmission unit, and residual data of the current block into a third image data transmission unit; and transmitting the first image data transmission unit in a first packet, the second image data transmission unit in a second packet, and the third image data transmission unit in a third packet.

According to another aspect of the present invention, there is provided an apparatus for transmitting image data, the apparatus including: a transmission unit generator to classify information about a location of a current block in a current picture into a first image data transmission unit, a motion vector of the current block into a second image data transmission unit, and residual data of the current block into a third image data transmission unit; and a transmitter to transmit the first image data transmission unit in a first packet, the second image data transmission unit in a second packet, and the third image data transmission unit in a third packet.

Each image data transmission unit may be an NAL unit.

The information about the location of the current block may be included in a slice header.

The residual data may be generated according to an inter prediction.

According to another aspect of the present invention, there is provided a computer readable recording medium having recorded thereon a program to execute the methods described above.

According to yet another aspect of the present invention, there is provided a system to transmit image data and conceal an error occurring in the image during transmission of the image data, the system including: a first apparatus for transmitting the image data, the first apparatus including: a transmission unit generator to classify information about a location of a current block in a current picture into a first image data transmission unit, a motion vector of the current block into a second image data transmission unit, and residual data of the current block into a third image data transmission unit, and a transmitter to transmit the first image data transmission unit in a first packet, the second image data transmission unit in a second packet, and the third image data transmission unit in a third packet; and a second apparatus for concealing the error in the image data, the second apparatus including: an error detector to detect the current block from the current picture, the error occurring in the current block, a searcher to search a reference picture decoded before the current picture using the residual data of the detected block, and an error concealer to conceal the error of the detected block based on a searching result of the searcher and the information about the location of the detected block in the current picture, wherein the error corresponds to a loss of the second image data transmission unit during the transmission of the image data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional image sequence;

FIG. 2 illustrates a conventional method of concealing a temporal error;

FIG. 3 is a diagram illustrating an apparatus for concealing an error of an image according to an embodiment of the present invention;

FIG. 4 illustrates a diagram of a searching method using residual data according to an embodiment of the present invention;

FIG. 5 is a flowchart illustrating a method of concealing an error of an image according to an embodiment of the present invention;

FIG. 6 is a block diagram illustrating an apparatus for transmitting image data according to an embodiment of the present invention;

FIG. 7 is a table illustrating types of a network abstraction layer (NAL) unit according to an embodiment of the present invention; and

FIG. 8 is a flowchart illustrating a method of transmitting image data according to an embodiment of the present invention.

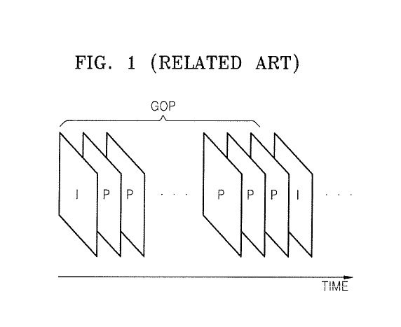

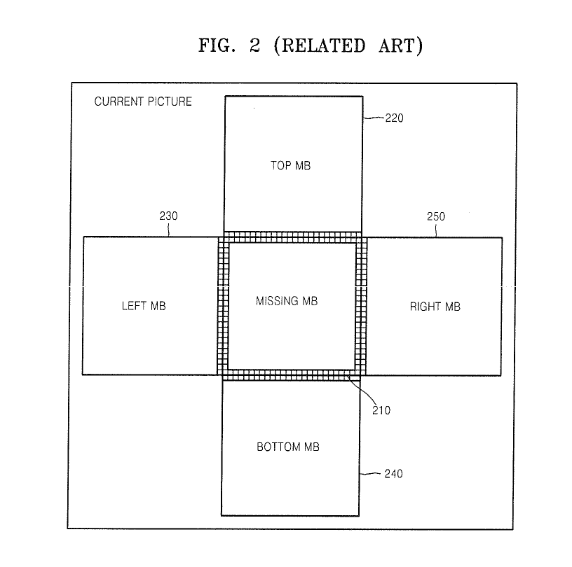

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

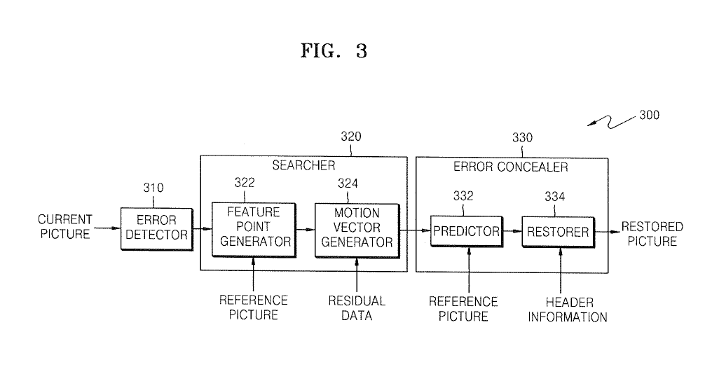

FIG. 3 is a diagram illustrating an apparatus 300 for concealing an error of an image according to an embodiment of the present invention. Referring to FIG. 3, the apparatus 300 includes an error detector 310, a searcher 320, and an error concealer 330. The apparatus 300 of FIG. 3 performs error concealment when an error occurs in a P picture. However, it is understood that the apparatus 300 according to aspects of the present invention can be applied to error concealment of all pictures (and not just a P picture) using a motion vector.

The error detector 310 detects a block in which an error occurs in a current picture (i.e., a block that is lost due to an error occurring while transmitting image data). The block in which image data is lost is detected from among blocks included in the decoded current picture. An image compression method (such as MPEG-1, MPEG-2, or MPEG-4 H.264/MPEG 4 AVC (Advanced Video Coding)) efficiently compresses image data. Thus, when an error occurs in a part of a bitstream including the image data, errors may result in a plurality of blocks.

Specifically, when an error occurs in a block included in a P picture, the error is propagated to another P picture that refers to the P picture having the error. Thus, a serious error occurs in the entire image sequence. Accordingly, the error detector 310 receives the current picture decoded by a decoder (not shown) and detects blocks having an error from the decoded current picture.

The searcher 320 searches for a reference picture using residual data of the block in which the error occurs, detected by the error detector 310. Data on one block includes location information of the block, a motion vector, and residual data of the block in the current picture. Generally, when one of the aforementioned three types of information is lost while transmitting the image data, the current block cannot be restored and, thus, an error should be concealed. According to an aspect of the present invention, the apparatus 300 conceals an error only when the motion vector is lost from among the three types of information described above.

The current picture (which is the P picture) is prediction encoded by referring to another picture, which is encoded before the current picture and sequentially precedes the current picture. Accordingly, the motion vector is important data about the P picture.

The size of the residual data is small since only a residue is encoded. The residue is a difference between a prediction value, generated by performing inter prediction between pictures, and an original value.

Accordingly, an error occurs mostly in the motion vector of the current block while transmitting the image data. In this regard, the apparatus 300 performs error concealment using the location information of the block in the current picture and residual data when only the motion vector is lost.

In order to perform the error concealment according to aspects of the present invention, the searcher 320 searches the reference picture for a block corresponding to the block in which the error occurs. The searcher 320 searches for the block by using the residual data of the block in which the error occurs. There is no limitation to the reference picture, and the reference picture may be a picture that directly precedes the current picture or a picture that was referred to for a prediction encoding while encoding the block in which the error occurs.

The searcher 320 includes a feature point generator 322 and a motion vector generator 324. The feature point generator 322 generates feature points of the reference picture decoded before the current picture. The feature points of the reference picture are generated as a pre-process, before searching the reference picture using the residual data. Accordingly, a number of operations can be reduced by searching only the feature points, (rather than the entire reference picture) by using the residual data.

A method of generating feature points by applying a Gaussian filter to the reference picture may, although not necessarily, be used. The feature points (such as a boundary or an edge of an object included in the reference picture) can be generated by applying the Gaussian filter to the reference picture. At this time, the number of feature points generated can be regulated by regulating the filtering intensity of the Gaussian filter. As the number of feature points decreases, the range of the search reduces, and thus the number of operations can be reduced. However, the result of the search may be inaccurate, and thus a number of feature points to be generated may be determined accordingly.

The motion vector generator 324 restores a motion vector of the block in which the error occurs by comparing the feature points of the reference picture generated in the feature point generator 322 and the residual data.

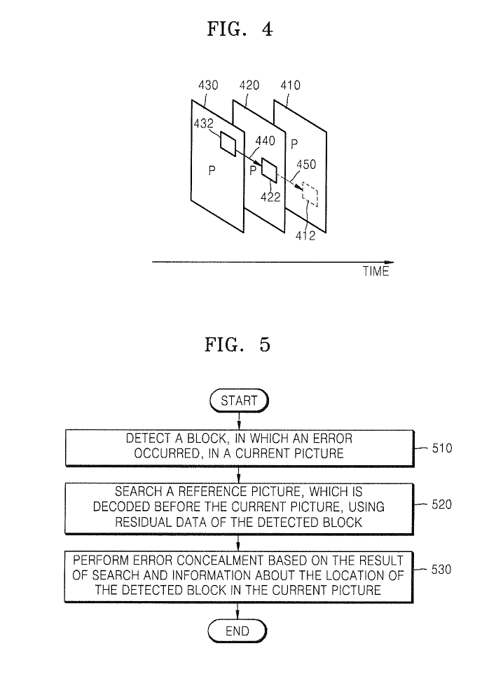

A block corresponding to the block in which the error occurs is searched for in the reference picture by searching the feature points generated by the feature point generator 322 using the residual data. Here, the range of the search can be reduced by calculating an optical flow of the feature points. For example, the optical flow of the feature points can be calculated by comparing a previous picture of the current picture and a previous picture of the previous picture. This will be described in detail with reference to FIG. 4.

FIG. 4 illustrates a diagram of a searching method using residual data according to an embodiment of the present invention. Referring to FIG. 4, an error occurs in a block 412 of a current picture 410.

In three sequentially consecutive pictures 410 through 430, feature points 422 and 432 of respective pictures 420 and 430 are generated, wherein the pictures 420 and 430 precede the current picture 410. Then, an optical flow 440 of the feature points 422 and 432 is calculated by comparing the feature points 422 and 432.

An optical flow 450 of feature points between the picture 420 that directly precedes the current picture 410 and the current picture 410 can be predicted using the calculated optical flow 440 between the two previous pictures 420 and 430. Accordingly, when an error occurs in a block 412 of the current picture 410, the location of a block corresponding to the block 412 in which the error occurs can be determined according to the predicted optical flow 450.

When the corresponding block is determined, only the surroundings of the determined location can be searched. In FIG. 4, the surroundings of the feature point 422 included in the picture 420 is searched using residual data.

Referring back to FIG. 3, when the block corresponding to the block in which the error occurs is searched for in the reference picture using the residual data, the motion vector generator 324 generates a motion vector between the block in which the error occurs and the corresponding block.

The error concealer 330 performs an error concealment based on the result of the search and information about the location of the block in which the error occurs in the current picture. The information about the location is included in a header (for example, in a slice header). The searcher 320 performs the search using the residual data of the block in which the error occurs, and the error concealment is performed based on the result of the search and the information about the location of the block in which the error occurs. As described above, the error concealment is performed based on information excluding a motion vector, which has the highest possibility of an error occurrence while transmitting image data.

The error concealer 330 includes a predictor 332 and a restorer 334. The predictor 332 predicts the block in which the error occurs based on the motion vector generated by the motion vector generator 324. A prediction block, which is a prediction value of the current block, is generated by searching the reference picture based on the motion vector.

The restorer 334 restores the block in which the error occurs by adding the prediction block generated by the predictor 332 and the residual data. The error concealment is completed by locating the restored block in a location determined according to the information about the location of the block in which the error occurs in the current picture.

Conventional error concealment uses a reference block, having the least SAD value, from among reference blocks selected by candidates of a motion vector as a restoration block of a current block. However, according to aspects of the present invention, a motion vector is pre-restored, a prediction block is searched for by the restored motion vector, and residual data is added to the prediction block. Accordingly, the current block can be more accurately restored.

FIG. 5 is a flowchart illustrating a method of concealing an error of an image according to an embodiment of the present invention. Referring to FIG. 5, an apparatus for concealing an error detects a block in which an error occurs in a current picture in operation 510.

The apparatus searches a reference picture, which is decoded before the current picture, using residual data of the block in which the error occurs (detected in operation 510) in occurs is searched for by generating feature points of the reference picture and comparing the generated feature points and the residual data. The reference picture may be a picture directly before the current picture or a picture referred to for a prediction encoding while encoding the block in which the error occurs.

The apparatus performs error concealment based on the result of the search in operation 520 and information on the location of the block in which the error occurs in the current picture in operation 530.

A prediction block of the block in which the error occurs is generated according to a motion vector between the block in which the error occurs, and the corresponding block searched for in operation 520. The error concealment is completed by restoring the block in which the error occurs by adding the prediction block and locating the residual block according to the information about the location.

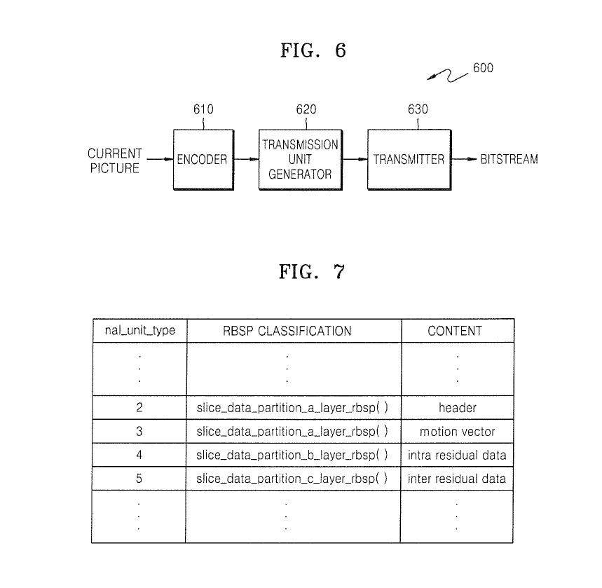

FIG. 6 is a block diagram illustrating an apparatus 600 for transmitting image data according to an embodiment of the present invention. Referring to FIG. 6, the apparatus 600 includes an encoder 610, a transmission unit generator 620, and a transmitter 630. The apparatus 600 of FIG. 6 transmits image data of a P picture, although not limited thereto. It is understood that according to aspects of the present invention, the apparatus 600 can transmit image data of any picture using a motion vector.

The encoder 610 encodes a current picture using an image compression method (such as MPEG-1, MPEG-2, MPEG-4 H.264/MPEG 4 AVC, or the like). As a result of encoding, header information is generated to include information about the location, in the current picture, of each block included in the current picture, a motion vector of each block, and residual data of each block.

The transmission unit generator 620 classifies the information about the location of the current block in the current picture, the motion vector, and the residual data generated by the encoder 610 into different image data transmission units.

In MPEG-4 H.264, a network abstraction layer (NAL) is defined. The NAL is between a video coding layer (VCL), which handles a moving image encoding process, and a lower system, which transmits and stores the encoded information. Before transmitting image data decoded in the VCL, the image data is classified into an image data transmission unit (i.e., an NAL unit), and the lower system transmits the decoded image data in packets, using NAL units as standard units. Here, one packet may include one or more NAL units.

Also, in an extended profile of H.264, a data partition that partitions image data according to priority is defined as a technology for protecting an important portion of image data that can be easily affected by a transmission error.

A header that includes information about the location of the current block having the highest priority in the current picture, an encoding type of a macroblock, and a motion vector are classified into one NAL unit. The classified NAL unit is transmitted as a channel that is stronger against an error occurrence than other channels in order to minimize a transmission error.

However, as described above, in a P picture, information about a motion vector is given a greatest deal of weight from among image data, and has a highest possibility of error occurrence. Accordingly, in order to perform error concealment by only using header information and residual data, excluding a motion vector, in which an error occurs during a transmission, according to aspects of the present invention, a transmission unit may be generated by separating a motion vector and a header.

FIG. 7 is a table illustrating types of an NAL unit according to an embodiment of the present invention. Referring to FIG. 7, a new type of NAL unit is illustrated that classifies header information and a motion vector in different NAL units. Specifically, types 2 and 3 of the NAL unit are defined so that the header and the motion vector are included in different NAL units.

Referring back to FIG. 6, the transmitter 630 transmits the image data transmission units classified in the transmission unit generator 620 in different packets. In other words, the header, the motion vector, and the residual data classified into different image data transmission units are transmitted in different packets.

Since the header, the motion vector, and the residual data are transmitted in different packets, if a packet including the motion vector (which has the highest possibility for an error occurrence) is lost, the error concealment can be performed using the header and the residual data.

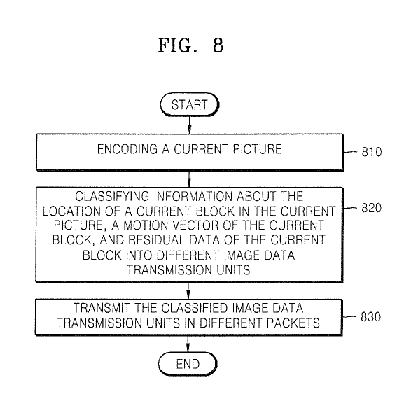

FIG. 8 is a flowchart illustrating a method of transmitting image data according to an embodiment of the present invention. Referring to FIG. 8, an apparatus for transmitting image data according to aspects of the present invention encodes a current picture according to a predetermined image compression method in operation 810.

The apparatus classifies information about the location of a current block in the current picture encoded in operation 810, a motion vector of the current block, and residual data of the current block in different image data transmission units in operation 820. Here, the image data transmission unit may be an NAL unit.

Then, the apparatus transmits the image data transmission units classified in operation 820 in different packets. Thus, the information about the location of the current block in the current picture (i.e., header information) and the motion vector are transmitted in different packets. Accordingly, even if a packet including the motion vector is lost during transmission, an error of the current block can be concealed using the header information and the residual data.

The invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and a computer data signal embodied in a carrier wave comprising a compression source code segment comprising the code and an encryption source code segment comprising the code (such as data transmission through the Internet). The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

According to aspects of the present invention, an error of a block can be concealed by searching a reference picture using residual data, thus reducing the number of operations required to conceal an error. Accordingly, an error can be efficiently concealed in a terminal with a lack of hardware resources for concealing the error.

Also, since a prediction block is first searched before a block in which an error occurs is restored by adding residual data, more accurate error concealment is possible than by a conventional error concealment.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of concealing an error of an image, the method comprising:
detecting a block in which the error occurs from a current picture;
searching a reference picture decoded before the current picture using residual data of the detected block; and
concealing the error of the detected block based on the searching of the reference picture and information about a location of the detected block in the current picture.

2. The method as claimed in claim 1, wherein the searching of the reference picture comprises:
generating feature points of the reference picture; and
restoring a motion vector of the detected block by comparing the generated feature points of the reference picture and the residual data of the detected block.

3. The method as claimed in claim 2, wherein the generating of the feature points comprises generating the feature points by applying a Gaussian filter to the reference picture.

4. The method as claimed in claim 2, wherein the restoring of the motion vector comprises:
searching only the feature points of the reference picture, using the residual data, for a block corresponding to the detected block; and
generating the motion vector between the detected block and the block corresponding to the detected block.

5. The method as claimed in claim 4, wherein the searching of the feature points of the reference picture for the block corresponding to the detected block comprises:
generating feature points of a second reference picture, decoded before the reference picture;
calculating a first optical flow between the feature points of the reference picture and the feature points of the second reference picture by comparing the feature points of the reference picture and the feature points of the second reference picture;
predicting a second optical flow between the current picture and the reference picture using the first optical flow; and
determining a location of the block corresponding to the detected block according to the predicted second optical flow.

6. The method as claimed in claim 2, wherein the concealing of the error comprises:
predicting the detected block by searching the reference picture based on the restored motion vector; and
restoring the detected block at a location determined by the information about the location by adding the predicted detected block and the residual data.

7. The method as claimed in claim 1, wherein the information about the location is included in a slice header.

8. An apparatus for concealing an error of an image, the apparatus comprising:
an error detector to detect a block In which the error occurs from a current picture;
a searcher to search a reference picture decoded before the current picture using residual data of the detected block; and
an error concealer to conceal the error of the detected block based on a searching result of the searcher and information about a location of the detected block in the current picture.

9. The apparatus as claimed in claim 8, wherein the searcher comprises:
a feature point generator to generate feature points of the reference picture; and
a motion vector restorer to restore a motion vector of the detected block by comparing the generated feature points of the reference picture and the residual data of the detected block.

10. The apparatus as claimed in claim 9, wherein the feature point generator generates the feature points by applying a Gaussian filter to the reference picture.

11. The apparatus as claimed in claim 9, wherein the motion vector restorer searches only the feature points of the reference picture, using the residual data, for a block corresponding to the detected block, and generates the motion vector between the detected block and the block corresponding to the detected block.

12. The apparatus as claimed in claim 11, wherein the motion vector restorer searches for the block corresponding to the detected block by generating feature points of a second reference picture decoded before the reference picture, calculating a first optical flow between the feature points of the reference picture and the feature points of the second reference picture by comparing the feature points of the reference picture and the feature points of the second reference picture, predicting a second optical flow between the current picture and the reference picture using the first optical flow, and determining a location of the block corresponding to the detected block according to the predicted second optical flow.

13. The apparatus as claimed in claim 9, wherein the error concealer comprises:
a predictor to predict the detected block by searching the reference picture based on the restored motion vector; and
a restorer to restore the detected block at a location determined by the information about the location by adding the predicted detected block and the residual data.

14. The apparatus as claimed in claim 8, wherein the information about the location is included in a slice header.

15. A method of transmitting image data, the method comprising:
classifying information about a location of a current block in a current picture into a first image data transmission unit;
classifying a motion vector of the current block into a second image data transmission unit;
classifying residual data of the current block into a third image data transmission unit; and
transmitting the first image data transmission unit in a first packet, the second image data transmission unit in a second packet, and the third image data transmission unit in a third packet.

16. The method as claimed in claim 15, wherein each image data transmission unit is a network abstraction layer (NAL) unit.

17. The method as claimed in claim 15, wherein the information about the location of the current block is included in a slice header.

18. The method as claimed in claim 9, wherein the residual data is generated according to an inter prediction.

19. An apparatus for transmitting image data, the apparatus comprising:
a transmission unit generator to classify information about a location of a current block in a current picture into a first image data transmission unit, a motion vector of the current block into a second image data transmission unit, and residual data of the current block into a third image data transmission unit; and
a transmitter to transmit the first image data transmission unit in a first packet, the second image data transmission unit in a second packet, and the third image data transmission unit in a third packet.

20. The apparatus as claimed in claim 19, wherein each image data transmission unit is a network abstraction layer (NAL) unit.

21. The apparatus as claimed in claim 19, wherein the information about the location of the current block is included in a slice header.

22. The apparatus as claimed in 19, wherein the residual data is generated according to an inter prediction.

23. A system to transmit image data and conceal an error occurring in the image during transmission of the image data, the system comprising:
a first apparatus to transmit the image data, the first apparatus comprising:
a transmission unit generator to classify information about a location of a current block in a current picture into a first image data transmission unit, a motion vector of the current block into a second image data transmission unit, and residual data of the current block into a third image data transmission unit, and
a transmitter to transmit the first image data transmission unit in a first packet, the second image data transmission unit in a second packet, and the third image data transmission unit in a third packet; and
a second apparatus to conceal the error in the image data, the second apparatus comprising:
an error detector to detect the current block from the current picture, the error occurring in the current block,
a searcher to search a reference picture decoded before the current picture using the residual data of the detected block, and
an error concealer to conceal the error of the detected block based on a searching result of the searcher and the information about the location of the detected block in the current picture, wherein
the error corresponds to a loss of the second image data transmission unit during the transmission of the image data.

24. The system as claimed in claim 23, wherein the searcher comprises:
a feature point generator to generate feature points of the reference picture; and
a motion vector restorer to restore the motion vector of the detected block by comparing the generated feature points of the reference picture and the residual data of the detected block.

25. The system as claimed in claim 23, wherein the error concealer comprises:
a predictor to predict the detected block by searching the reference picture based on the restored motion vector; and
a restorer to restore the detected block at a location determined by the information about the location by adding the predicted detected block and the residual data.
